(19) United States
(12) Patent Application Publication
(10) Pub. No.: US 2010/0318925 A1
(43) Pub. Date: Dec. 16, 2010

(54) INTEGRATING UPDATES INTO A SOCIAL-NETWORKING SERVICE

(75) Inventors: Bhupinder Singh Sethi, Redmond, WA (US); Paul Elliott, Woodinville, WA (US); Dare Obasanjo, Renton, WA (US); Omar Shahine, Menlo Park, CA (US)

Correspondence Address: SHOOK, HARDY & BACON L.L.P.;(MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/483,801

(22) Filed: Jun. 12, 2009

(51) Int. Cl. G06F 3/01

(52) U.S. Cl. 715/760; 726/3; 715/742; 705/319

(57) ABSTRACT

Embodiments of the present invention relate to systems, methods, and computer readable media for providing to a first user of a first social-networking site information associated with a second user of a second social-networking site, where the second user is not registered at the first social-networking site. In some embodiments, the first user registered at the first social-networking site requests information associated with the second user at the second social-networking site to be added to the presentation feed of the first user on the first social-networking site. After the first user is authenticated by a second social-networking site to receive information associated with the second user, the information associated with the second user is displayed to the first user on the first social-networking site.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer readable media for providing to a first user of a first social-networking site information associated with a second user of a second social-networking site, where the second user is not registered at the first social-networking site. In one embodiment, the first user registered at the first social-networking site requests information associated with the second user at the second social-networking site to be added to the presentation feed of the first user on the first social-networking site. After the first user is authenticated (if authenticated) by a second social-networking site to receive information associated with the second user, the information associated with the second user is presented to the first user on the presentation feed of the first social-networking site.

### BRIEF DESCRIPTION OF THE SEVERAL VIEWS OF THE DRAWINGS

Illustrative embodiments of the present invention are described in detail below with reference to the attached drawing figures:

FIG. 1 depicts an exemplary computing device suitable for use in connection with embodiments of the present invention;

FIG. 2A depicts an exemplary flow illustration of integrating status updates of a first person from a first social-networking site into status updates of a second user on a second social-networking site in accordance with an embodiment of the present invention;

FIG. 2B depicts an exemplary flow of integrating status updates of a first person from a first social-networking site and from a third social-networking site into status updates of a second user on a second social-networking site in accordance with an embodiment of the present invention;

FIG. 3 depicts integrating updates from a first social-networking site and updates from a second social-networking site in accordance with an embodiment of the present invention.

FIG. 4A illustrates the integration of updates from a second social-networking site into a presentation of a first social-networking site in accordance with an embodiment of the present invention;

FIG. 4B illustrates an integration of updates from a second social-networking site and a third social-networking site into a presentation of a first social-networking site in accordance with an embodiment of the present invention;

FIG. 5 depicts a modified presentation of a first social-networking site that presents feeds from a second social-networking site in accordance with an embodiment of the present invention;

FIG. 6 depicts a modified presentation of a first social-networking site that incorporates feeds from a second social-networking site into the presentation feed of the first social-networking site in accordance with an embodiment of the present invention;

FIG. 7 depicts a modified presentation of a first social-networking site that incorporates feeds from a second social-networking site to a presentation feed of a third social-networking site in accordance with an embodiment of the present invention;

FIG. 8 illustrates various user connections in a first social-networking site in accordance with an embodiment of the present invention;

FIG. 9 depicts an illustrative user interface presented at a first social-networking site to receive input to verify a user's authentication to receive information from a second social-networking site in accordance with an embodiment of the present invention;

FIG. 10 depicts an illustrative system for integrating updates retrieved and/or received from a first social-networking site server and a second social-networking site server and transmitting the updates to a social-networking site to be integrated in accordance with an embodiment of the present invention;

FIG. 11 illustrates a system for receiving updates communicated from a first social-networking site server and a second social-networking site server at a social-networking site to be integrated in accordance with an embodiment of the present invention;

FIG. 12 is a flow diagram illustrating a method of receiving requested updates upon authentication from a first social-networking site server that a first user is associated with necessary authentication information in accordance with an embodiment of the present invention;

FIG. 13 is a flow diagram illustrating a method of receiving requested updates from a second user once a first user is authenticated, based on information provided by the first user, to view updates from the second user in accordance with an embodiment of the present invention;

FIG. 14 is a flow diagram illustrating a method of presenting in a first social-networking site activity logged in a second social-networking site, in accordance with an embodiment of the present invention;

FIG. 15 is a flow diagram illustrating a method of presenting in a first social-networking site activity logged in a second social-networking site, in accordance with an embodiment of the present invention; and

FIG. 16 is a flow diagram showing another embodiment of a method of associating at least a first category of social-networking activity from a first social-networking service and a second category of social-networking activity from a second social-networking service with a user profile at the first social-networking service, in accordance with an embodiment of the present invention.

### DETAILED DESCRIPTION

The subject matter of embodiments of the present invention is described with specificity herein to meet statutory requirements. Although the terms “step” and/or “block” or “module” etc. might be used herein to connote different components of methods or systems employed, the terms should not be interpreted as implying any particular order among or between various steps herein disclosed unless and except when the order of individual steps is explicitly described.

Embodiments of the present invention relate to systems, methods, and computer readable media for providing to a first user of a first social-networking site information associated with a second user of a second social-networking site, where the second user is not registered at the first social-networking site. In some embodiments, the first user registered at the first social-networking site requests information associated with the second user at the second social-networking site to be added to the presentation feed of the first user on the first social-networking site. A presentation feed includes a presentation of updates, such as status updates, that may be input by one or more people. After the first user is authenticated (if required) by a second social-networking site to receive information associated with the second user, the information associated with the second user is displayed to the first user on the presentation feed of the first social-networking site.

Accordingly, in one aspect, the present invention provides computer-readable media having computer-executable instructions embodied thereon that, when executed, perform a method of presenting in a first social-networking site activity logged in a second social-networking site. The method includes presenting a first social-networking site interface on a remote computing device to a first user who is associated with the first social-networking site. The method also includes receiving information from the first user that identifies a second user who is associated with the second social-networking site. Activity information provided by the second user to the second social-networking site is retrieved by a first server associated with said first social-networking site requesting said activity information from a second server that is associated with said second social-networking site. The activity information of the second user is presented on the first social-networking site to the first user. In some embodiments, activity information includes user updates, such as status updates.

In another aspect, the present invention provides computer-readable media having computer-executable instructions embodied thereon that, when executed, perform a method of presenting in a first social-networking site activity logged in a second social-networking site. The method includes a first user is authenticating at an application server that hosts a second social-networking site as being registered at the first social-networking site. A subscription request is received from the first user to receive activity information related to a second user, the second user associated with the second social-networking site. The method also includes retrieving activity information provided by the second user to the second social-networking site. Further, the activity information retrieved is presented to the first user.

A third aspect of the present invention provides a way of associating at least a first category of social-networking activity from a first social-networking service and a second category of social-networking activity from a second social-networking service with a user profile at the first social-networking service. The method includes receiving a request from the user to login to the first social-networking service. The user is authenticated as being registered at the first social-networking service. A request is received from the user to add the second category of social-networking activity to the user profile at the first social-networking service. The method also includes determining that the user must be authenticated by the second social-networking service to receive the second category of social-networking activity. A user interface is generated to query the user to enter authentication information associated with the second social-networking service and authentication information is received from the user. The authentication information of the user is sent to the second social-networking service. Confirmation is received from the second social-networking service that the user is authenticated. Additionally, the second category of social-networking activity is added to the user profile on the first social-networking site.

Having briefly described an overview of embodiments of the present invention, an exemplary operating environment suitable for implementing embodiments hereof is described below.

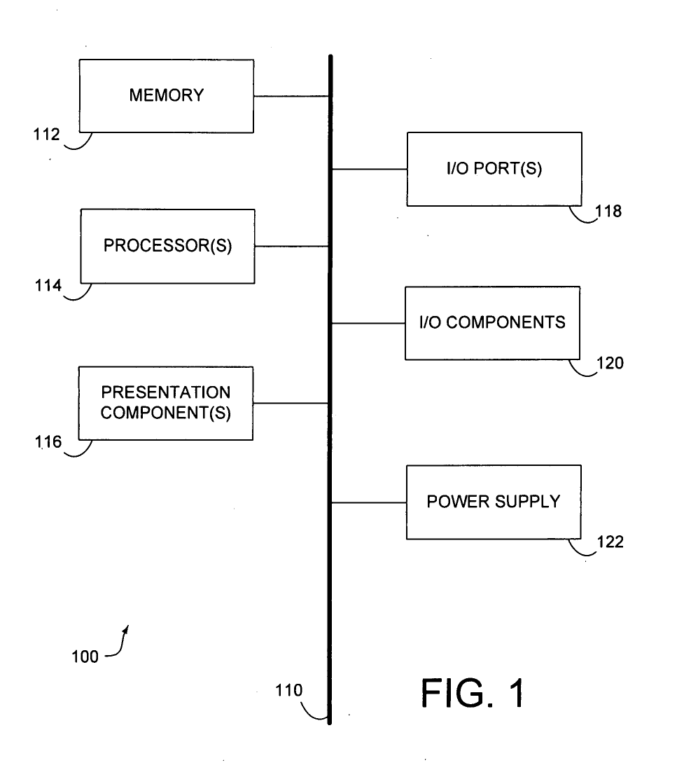

Referring to the drawings in general, and initially to FIG. 1 in particular, an exemplary computing device suitable for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of modules/components illustrated.

Embodiments may be practiced in a variety of system configurations, including handheld devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation modules 116, input/output (I/O) ports 118, I/O modules 120, and an illustrative power supply 122. Bus 110 represents what may be one or more busses (such as an address bus, data bus, or combination thereof). Although the various blocks of FIG. 1 are shown with lines for the sake of clarity, in reality, delineating various modules is not so clear, and metaphorically, the lines would more accurately be grey and fuzzy. For example, one may consider a presentation module such as a display device to be an I/O module. Also, processors have memory. The inventors hereof recognize that such is the nature of the art, and reiterate that the diagram of FIG. 1 is merely illustrative of an exemplary computing device that can be used in connection with one or more embodiments. Distinction is not made between such categories as “workstation,” “server,” “laptop,” “handheld device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier waves or any other medium that can be used to encode desired information and be accessed by computing device 100.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O modules 120. Presentation module(s) 116 present data indications to a user or other device. Exemplary presentation modules include a display device, speaker, printing module, vibrating module, and the like. I/O ports 118 allow computing device 100 to be logically coupled to other devices including I/O modules 120, some of which may be built in. Illustrative modules include a microphone, joystick, game pad, satellite dish, scanner, printer, wireless device, and the like.

People use the internet to keep in touch with friends and family. The availability of e-mail has allowed people to send messages to friends, but until recently, it was difficult for e-mail users to send pictures or large e-mails without worrying about filling up a friend's e-mail inbox. This problem was solved by the introduction of social-networking websites, where people can sign up and create an on-line profile where they can post pictures and updates and keep in touch with friends and family. One drawback, however, of social-networking websites is that many people have friends who have created profiles on a number of different social-networking websites. While a person can check updates from friends on the person's same, first social-networking website, the person must log onto another social-networking website to view updates from other friends who are not registered at the person's first social-networking website. This application provides ways for a person to receive updates about friends who are registered on other social-networking websites, even when the friends aren't signed up on the person's social-networking website. Embodiments of the present invention provide ways for a person who is registered at a social-networking site to add information from friends who are not registered at the person's social-networking site, but who are registered at other social-networking sites.

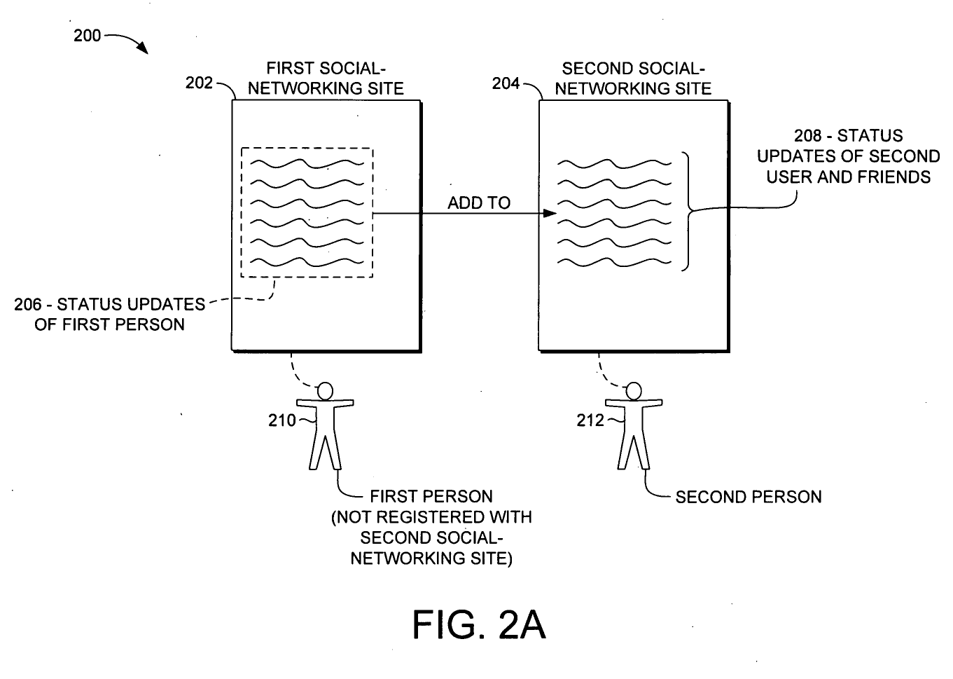

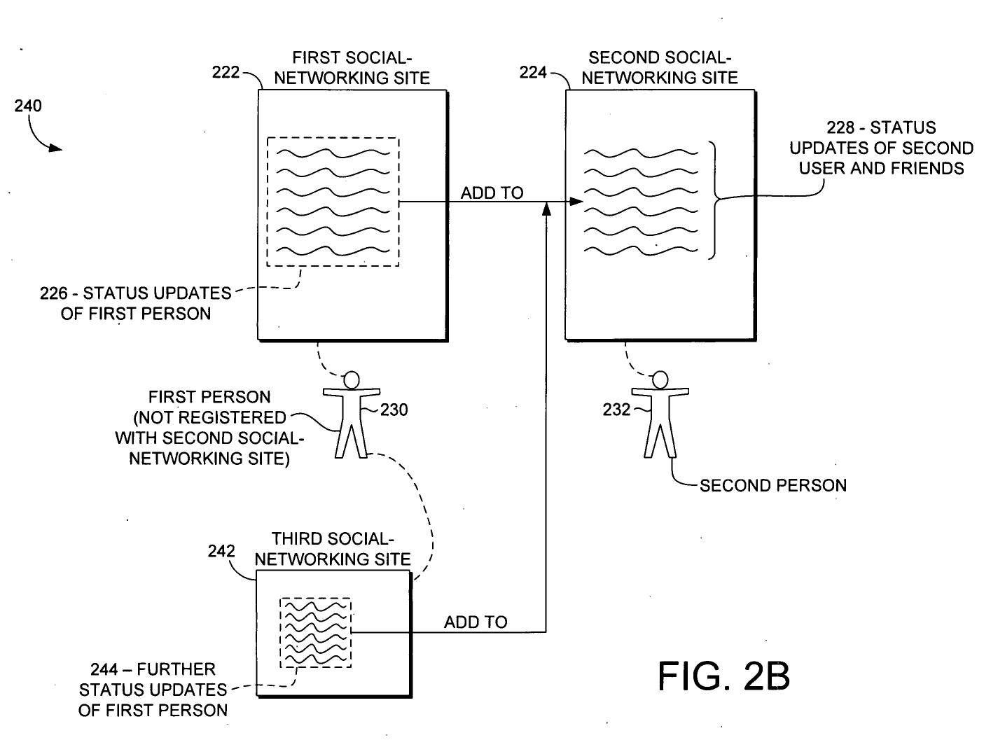

FIG. 2A depicts an exemplary flow illustration 200 of integrating status updates 206 of a first person 210 from a first social-networking site 202 into status updates 208 of a second user 212 on a second social-networking site 209 in accordance with an embodiment of the present invention;

The flow illustration 200 includes a first social-networking site 202; a second social-networking site 204; status updates 206 of a first person 210; status updates 208 of a second person 212 and friends. In some embodiments, the second person 212 is registered with the second social-networking site 204 and the first person 210 is not registered with the second social-networking site 204.

In alternative embodiments, the first person 210 provides updates 206 to the first social-networking site 202. The first person 210 may be registered at the first social-networking site 202. At a second social-networking site 204, a second person 212 may be registered at the second social-networking site 204, and the second person 212 may provide updates 208 to the second social-networking site 204. The updates 208 may comprise updates from the second person 212 and/or may comprise updates from friends of the second person 212. In further embodiments, one or more of the friends of the second person 212 may be registered at the second social-networking site. In some embodiments of the invention, the status updates 206 of the first person 210 as posted on the first social-networking site 202 may be added to the status updates 208 of the second person 212 as posted on the second social-networking site 204. Further, in alternative embodiments, the first person 210 is not registered at the second social-networking site 204.

FIG. 2B depicts an exemplary flow illustration 240 of integrating status updates of a first person from a first social-networking site and from a third social-networking site into status updates of a second user on a second social-networking site in accordance with an embodiment of the present invention. The flow illustration 240 includes a first social-networking site 222; a second social-networking site 224; status updates 226 of a first person 230; status updates 228 of a second person 232 and friends; a first person 230; a second person 232; a third social-networking site 242, and further status updates 244 of the first person 230. In some embodiments, the second person 232 is registered with the second social-networking site 224 and the first person 230 is not registered with the second social-networking site 224. Further, in alternative embodiments, the first person 230 is not registered at the second social-networking site 224.

In alternative embodiments, the first person 230 provides updates 226 to the first social-networking site 222. The first person 230 may also provide further status updates 244 to the third social-networking site 242. The first person 230 may be registered at the first social-networking site 222. Also or alternatively, the first person 230 may be registered at the third social-networking site 242. At a second social-networking site 224, a second person 232 may be registered at the second social-networking site 224, and the second person 232 may have status updates 228 posted on the second social-networking site 224. The status updates 228 may comprise updates from the second person 232 and/or may comprise updates from friends of the second person 232. In further embodiments, one or more of the friends of the second person 232 may be registered at the second social-networking site. In some embodiments of the invention, the status updates 226 of the first person 230 as posted on the first social-networking site 222 may be added to the status updates 228 of the second person 232 as posted on the second social-networking site 224. Additionally or alternatively, the further status updates 244 of the first person 230 as posted on the third social-networking site 242 may be added to the status updates 228 of the second person 232 as posted on the second social-networking site 224.

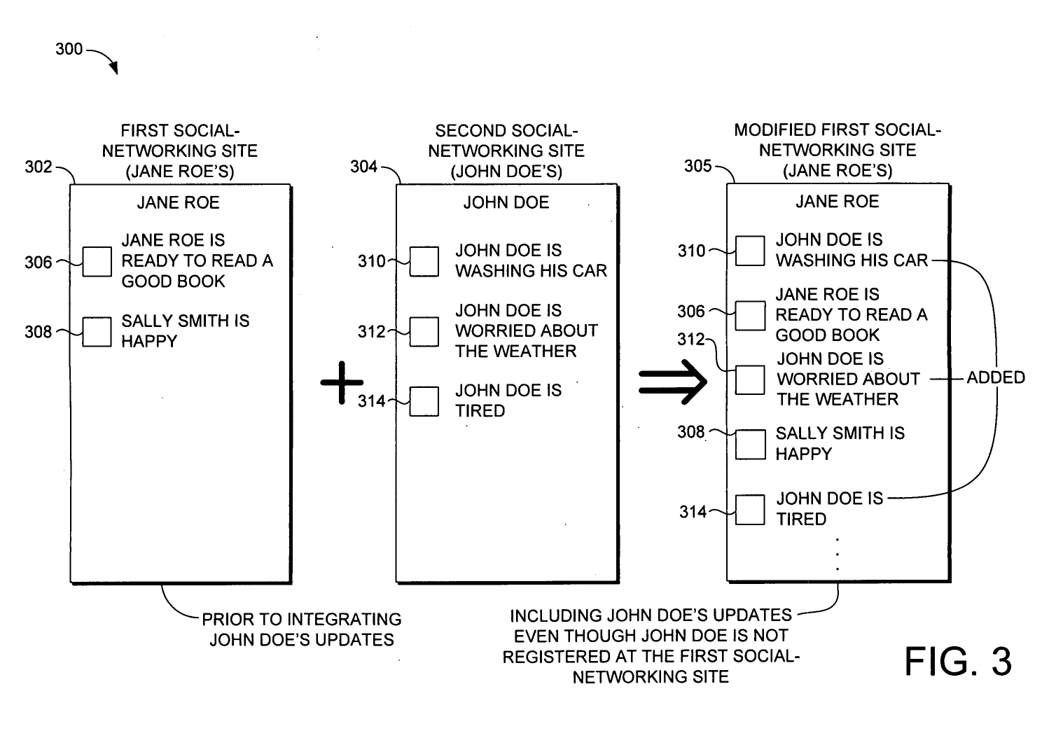

FIG. 3 depicts integrating updates 300 from a first social-networking site and updates from a second social-networking site in accordance with an embodiment of the present invention. The presentation 300 includes a first social-networking site 302; a second social-networking site 304; a modified first social-networking site 305; a status update 306 from a first person; a status update 308 from a second person; a first status update 310 of a third person; a second status update 312 of a third person; and a third status update 314 of a third person. In some embodiments, the first social-networking site 302 is registered to the first person, Jane Roe; the second person, Sally Smith, is a friend of Jane Roe; and the status updates 310, 312, and 314 of the third person, John Doe, are integrated from the second social-networking site 304 into the modified first social-networking site 305.

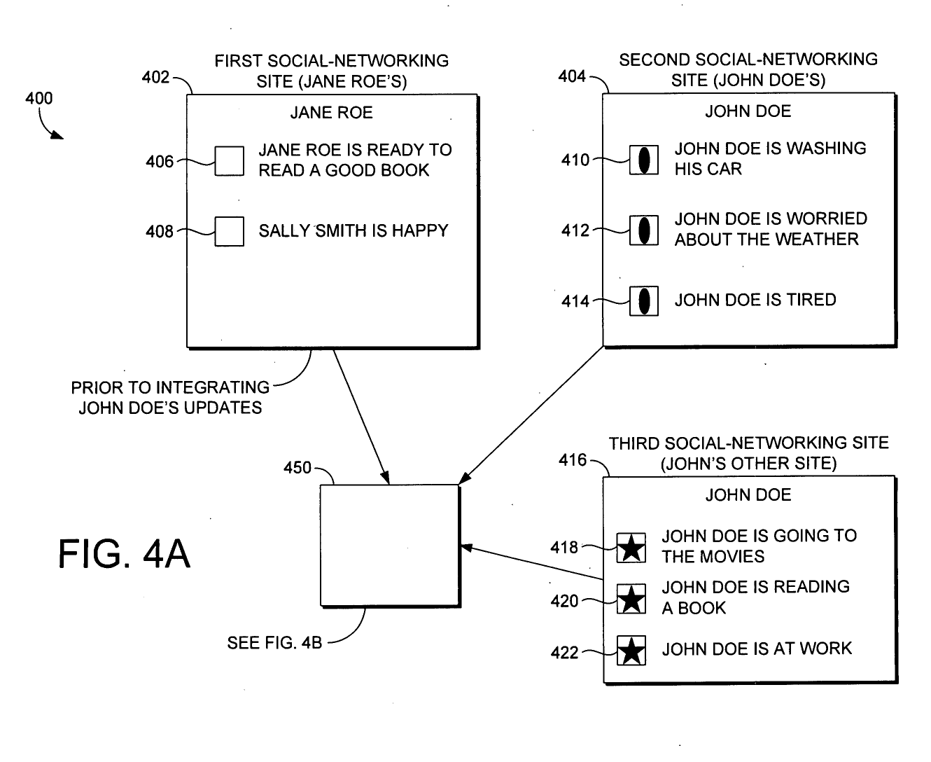

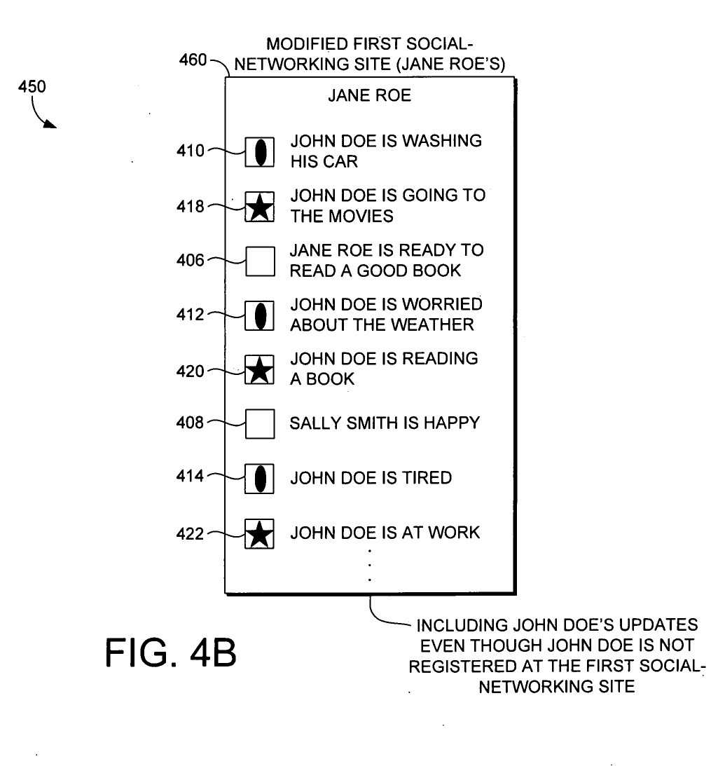

FIG. 4A illustrates the integration 400 of updates from a second social-networking site into a presentation of a first social-networking site in accordance with an embodiment of the present invention. It is the integration of updates from the second social-networking site and the third social-networking site that allows a person to receive updates from assorted friends and family independent of the social-networking sites at which the friends and family are registered. The presentation 400 includes a first social-networking site 402; a second social-networking site 404; a third social-networking site 416; a status update 406 from a first person; a status update 408 from a second person; a first status update 410 from a third person; a second status 412 update from a third person; a third status update 414 from a third person; a first further status update 418 from a third person; a second further status update 420 from a third person; a third further status update 422 from a third person, and an integration 450 of updates from the first, second and third social-networking sites, 402, 404, and 416, respectively. In some embodiments, the first social-networking site 402 is registered to the first person, Jane Roe; the second person, Sally Smith, is a friend of Jane Roe; and the status updates 410, 412, 414, 418, 420, and 422 of the third person, John Doe, are not yet integrated into the first social-networking site 402.

FIG. 4B illustrates an integration 450 of updates from a second social-networking site and a third social-networking site into a presentation of a first social-networking site in accordance with an embodiment of the present invention. As mentioned above, t is the integration of updates from the second social-networking site and the third social-networking site that allows a person to receive updates from assorted friends and family independent of the social-networking sites at which the friends and family are registered. Integration 450 includes a modified first social-networking site 460; a status update 406 from a first person; a status update 408 from a second person; status updates 410, 412, and 414 from a third person; and further status updates 418, 420, and 422 from the third person. Similar to FIG. 4A, in some embodiments, the modified first social-networking site 460 is registered to the first person, Jane Roe; the second person, Sally Smith, is a friend of Jane Roe; and the status updates 410, 412, 414, 418, 420, and 422 of the third person, John Doe, are integrated into the modified first social-networking site 460.

Thus, even though John never even registered with the social-networking service that Jane is associated with, our technology enables Jane to receive John's related updates, namely, updates John makes to his status via his own social-networking service.

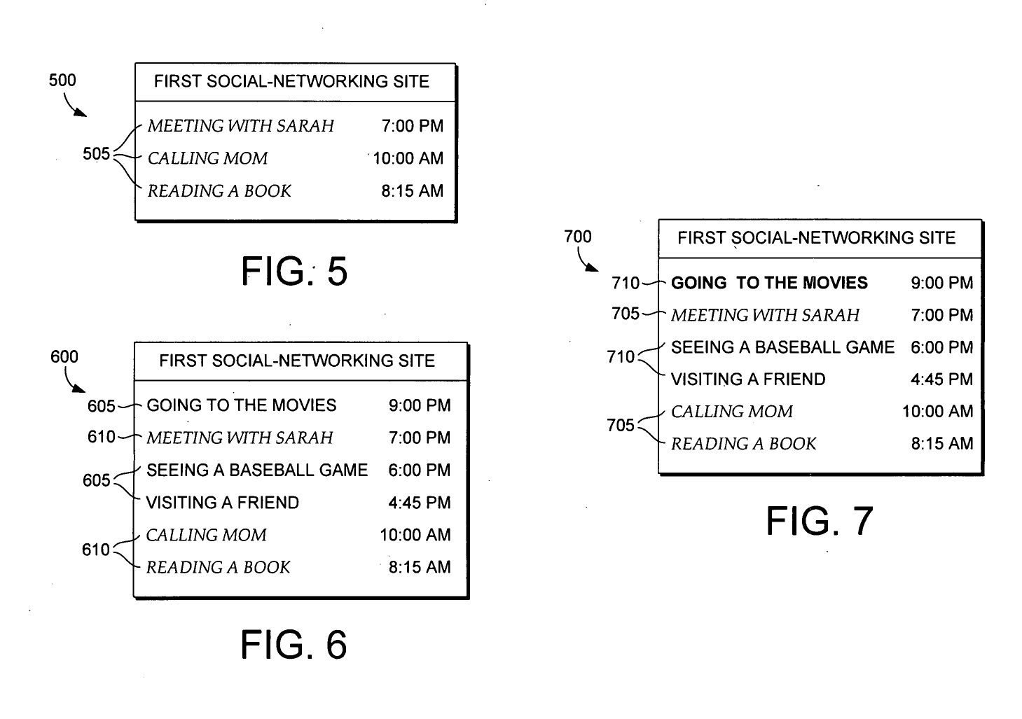

FIG. 5 depicts a modified presentation 500 of a first social-networking site that presents feeds from a second social-networking site in accordance with an embodiment of the present invention. The second social-networking feeds 505 may be presented in a font, where the font may be selected from a predefined number of fonts. As seen in FIG. 5, a first user registered at a first social-networking site receiving requested information about a second user from a second social-networking site might choose to retain the font associated with the second social-networking site when presenting updates from the second social-networking site in the feed the user has for the second user on the first social-networking site. In this way, the user may use the difference in presentation to remind the user of the origin of the updates.

In another example, FIG. 6 depicts a modified presentation 600 of a first social-networking site that incorporates feeds from a second social-networking site into the presentation feed of the first social-networking site in accordance with an embodiment of the present invention. The first social-networking feeds 605 may be presented in a first font, while the second social-networking feeds 610 may be presented in a second font. The first font and second font may be selected from a predefined number of fonts, respectively. In contrast to the presentation 500 as seen in FIG. 5, the presentation 600 in FIG. 6 contains updates associated with a second user from both the first social-networking site and the second social-networking site. For example, if a second user has a profile associated with the first social-networking site as well as a profile associated with a second social-networking site, the first user may prefer to access information associated with the second user from both the first social-networking site and the second social-networking site at a profile the first user has for the second user at the first social-networking site. As seen in FIG. 6, the updates from the first social-networking site are distinguished from the updates from the second social-networking site based on the use of differing fonts for updates from the first social-networking site and the second social-networking site, respectively. The fonts used to distinguish the two sources of the updates may be selected from a predetermined set of fonts. The fonts may also be associated with the presentation of updates from the first and second social-networking sites, respectively, or may be selected by a user as being associated with the first and second social-networking sites.

Alternatively, a user may choose to have all updates associated with a second user to be presented in a consistent font, e.g., the presentation of the font independent from the origin of the update(s). In additional embodiments, the user may have hybrid update presentations, wherein a hybrid update presentation may be an updated presentation that combines updates from a first social-networking site and a second social-networking site, that are analyzed for duplicate updates. In some embodiments, the user may delete duplicate updates from a second user, such as updates that are from a first social-networking site and a second social-networking site, respectively.

In another embodiment, FIG. 7 depicts a modified presentation 700 of a first social-networking site that incorporates feeds from a second social-networking site to a presentation feed of a third social-networking site in accordance with an embodiment of the present invention. The second social-networking feeds 705 may be presented in a first font, while the third social-networking feeds 710 may be presented in a second font. The first font and second font may be selected from a predefined number of fonts, respectively. Similar to FIG. 6, the presentation 700 of FIG. 7 is a hybrid update presentation, wherein the hybrid update presentation of FIG. 7 combines updates from a second social-networking site and a third social-networking site. As discussed above with reference to FIG. 6, the two fonts used to represent updates from the second social-networking site and the third social-networking site may be used to highlight the origin of the updates from the second social-networking site and third social-networking site, respectively. Alternatively, the updates from both the second and third social-networking sites may be in a font matching a font associated with the first social-networking site.

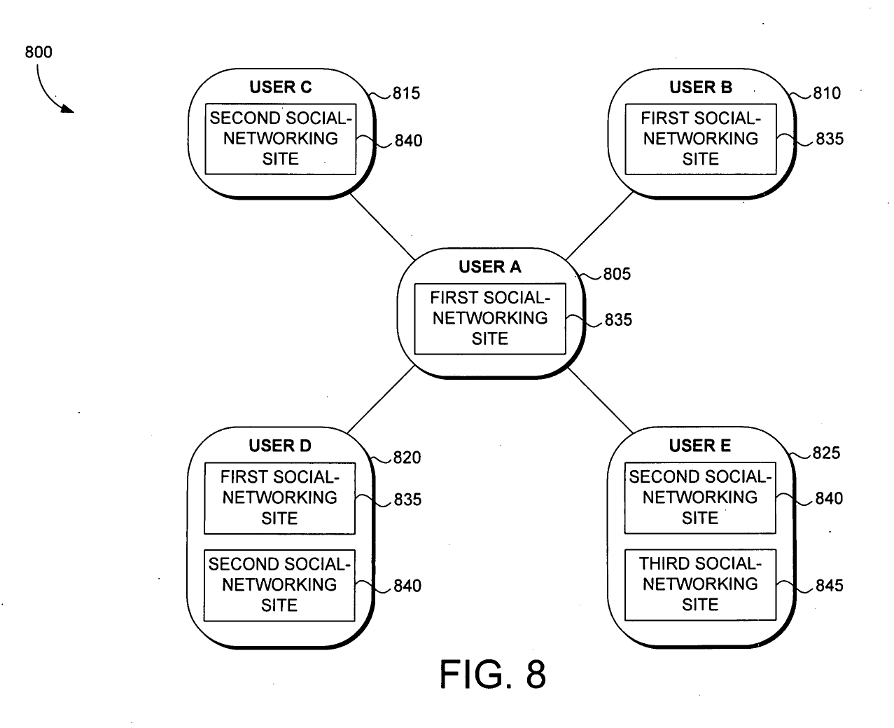

FIG. 8 illustrates various user connections 800 in a first social-networking site in accordance with an embodiment of the present invention. In particular, network 800 includes a number of users, Users B-E, with whom a central user, User A, is associated. In some embodiments, User A is stationed at a central node 805, with Users B-E stationed at nodes 810, 815, 820, and 825, respectively, with each node connected to node 805. Additionally, each node 805-825 is comprised of identification labels 835, 840, and 845 representing a first social-networking site, a second social-networking site, and a third social-networking site, respectively. Each identification label identifies the social-networking site(s) associated with each node.

For example, in some embodiments, node 805 is associated with a first social-networking site. As such, node 805 includes identification label 835. Similarly, node 810 is also associated with a first social-networking site, thus also includes identification label 835. The information relationship A-B between node 805 and node 810 is between two users associated with a first social-networking site. An information relationship includes the information presented to a first user (such as User A) that is associated with a second user (such as User B). In some embodiments, an information relationship for A-B is defined as information from User B that is presented to User A.

In contrast to nodes 805 and 810, node 815 is associated with a second social-networking site. As such, node 815 includes identification label 840. As such, the information relationship A-C between node 805 and 815 is between two users of two separate social-networking sites.

In order for information from User C to be presented to User A, User A may have to be authenticated by the second social-networking site associated with User C. Authentication may be required when, for example, User C restricts access to his information to only a certain number and/or type of people (e.g., his friends or people from a specific geographic area or people graduating from a particular school, among other examples). In alternative embodiments, when a first user, such as User C, does not restrict access to his information, a second user, such as User A, requesting information about the first user may not be required to be authenticated by the second social-networking site.

In further contrast to nodes 805-815, node 820 is associated with a first social-networking site and a second social-networking site. As such, node 820 includes identification label 835 and 840, respectively. Nodes comprising more than one identification label may be considered hybrid nodes. The information relationship A-D between node 805 and 820 is between a first user and information associated with a second user, the activity information comprising information from the second user found on the first social-networking site and a second social-networking site.

Similar to node 820, node 825 is also a hybrid node associated with two social-networking sites: a second social-networking site and a third social-networking site. As such, node 825 includes identification label 840 and 845, respectively. The information relationship A-E between node 805 and 825 is between a first user and information associated with a second user, the activity information comprising information from the second user found on two social-networking sites, each social-networking site separate from the first social-networking site.

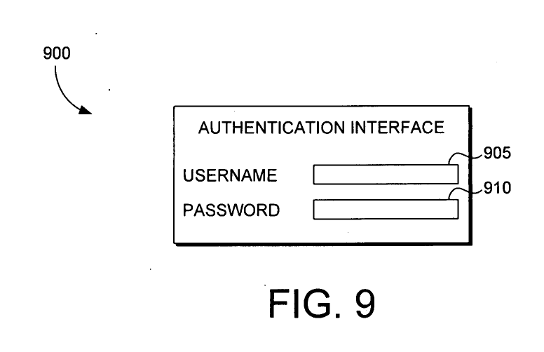

FIG. 9 depicts an illustrative user interface 900 presented at a first social-networking site to receive input to verify a user's authentication to receive information from a second social-networking site in accordance with an embodiment of the present invention. As discussed above, in some embodiments, a first user must be authenticated by a second social-networking site before the first user may receive nonpublic information about a second user. In alternative embodiments, the second social-networking site may require the first user to be authenticated as being associated with the second social-networking site before any information associated with a second user may be transferred to the first social-networking site, independent of whether the requested information from the second user is public or nonpublic. In either case, to be authenticated, the first user may provide authentication information to the second social-networking site. In some embodiments, the user may enter authentication information at a user interface, such as interface 900, that is presented at a first social-networking site.

Interface 900 may be configured to receive user authentication information. As such, interface 900 may comprise a username input 905 and a password input 910. In alternative embodiments, a user may be associated with GPS-based location and may only need to enter a verification password. In other embodiments, a user may have a username and/or password saved to his computer, in which case a user authentication screen may not be visibly displayed to the user, or may be displayed briefly. In alternative embodiments, a user's initial login to a first social-networking site may be used to authenticate both the first social-networking site and one or more associated social-networking sites. In alternative embodiments, a first user may request information related to a second user, where the second user is associated with a second social-networking site, where the second social-networking site is at least one of the one or more social-networking sites. In some embodiments where a first user has been authenticated at the first social-networking site to access the second social-networking site, a second authentication may not be needed.

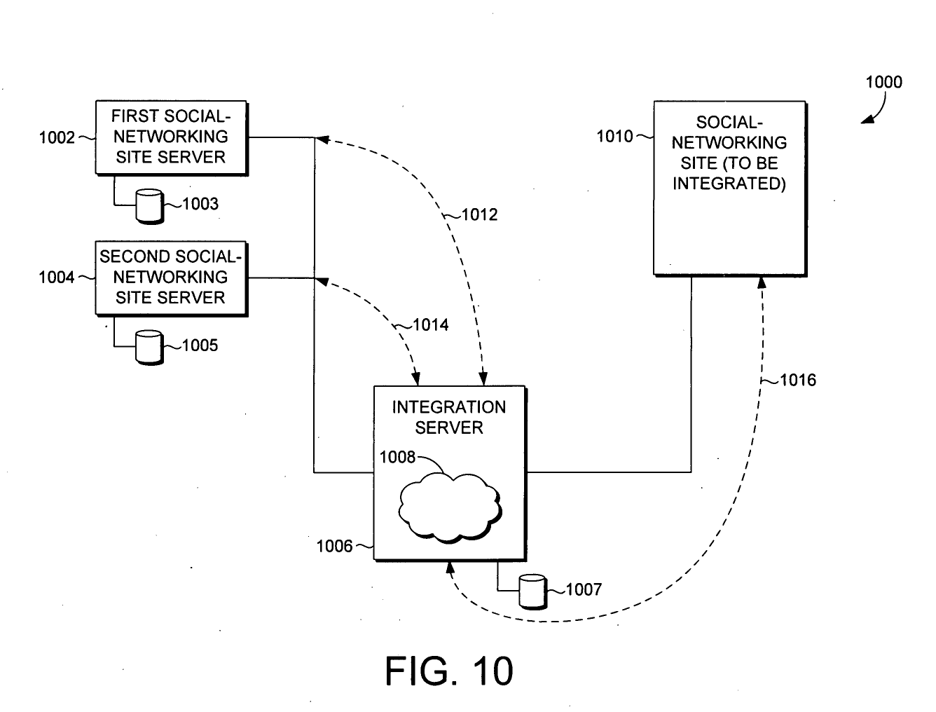

FIG. 10 depicts an illustrative system 1000 for integrating updates retrieved and/or received from a first social-networking site server and a second social-networking site server and transmitting the updates to a social-networking site to be integrated in accordance with an embodiment of the present invention. The system includes a first social-networking site server 1002; a first database 1003; a second social-networking site server 1004; a second database 1005; an integration server 1006; a third database 1007; an integration application 1008; a social-networking site of interest 1010; a connection 1012 between integration server 1006 and first social-networking site server 1002; a connection 1014 between integration server 1006 and second social-networking site server 1004; and a connection 1016 between integration server 1006 and social-networking site of interest 1010.

In some embodiments, connections 1012, 1014, and 1016 may be wired or wireless. Examples of particular wired embodiments, within the scope of the present invention, include USB connections and cable connections. Examples of particular wireless embodiments, within the scope of the present invention, include a near-range wireless network and radio-frequency technology. It should be understood and appreciated that the designation of “near-range wireless network” is not meant to be limiting, and should be interpreted broadly to include at least the following technologies: negotiated wireless peripheral (NWP) devices; short-range wireless air interference networks (e.g., wireless personal area network (wPAN), wireless local area network (wLAN), wireless wide area network (wWAN), Bluetooth™, and the like); wireless peer-to-peer communication (e.g., Ultra Wideband); and any protocol that supports wireless communication of data between devices. Additionally, persons familiar with the field of the invention will realize that a near-range wireless network may be practiced by various data-transfer methods (e.g., satellite transmission, telecommunications network, etc.) that are different from the specific illustrated embodiments.

In some embodiments, integration server 1006 may retrieve and/or receive updates from a first or second social-networking site server, 1002 and 1004, respectively. The updates may be stored at the first social-networking site server 1002 or the updates may be stored in a first database 1003 associated with the first social-networking site server 1002. Additionally or alternatively, the updates may be stored at the second social-networking site server 1004 or the updates may be stored in a second database 1005 associated with the second social-networking site server 1004. The updates may be send from the first and/or second social-networking site server 1002/1004 in response to a request from a social-networking site, such as social-networking site 1010, for updates to be integrated into the social-networking site 1010. In response, the first and/or second social-networking site server 1002/1004 may provide requested updates to the integration server 1006. The updates may be stored at the integration server 1006 or the updates may be stored at a database 1007 associated with the integrated server 1006.

In alternative embodiments, updates may be retrieved by the integration server 1006 in response to a request from a social-networking site, such as social-networking site 1010. In some embodiments, integration server 1006 may receive a request for updates from the social-networking site 1010. The integration server 1006 may then generate a request for updates from the first and/or second social-networking site server 1002/1004. In response to the request for updates from the integration server 1006, the first and/or second social-networking site server 1002/1004 may send a response to the integration server 1006, where the response includes the requested updates. The request for updates and/or the updates sent in response to the request for updates may be transmitted via connection 1012 and/or connection 1014.

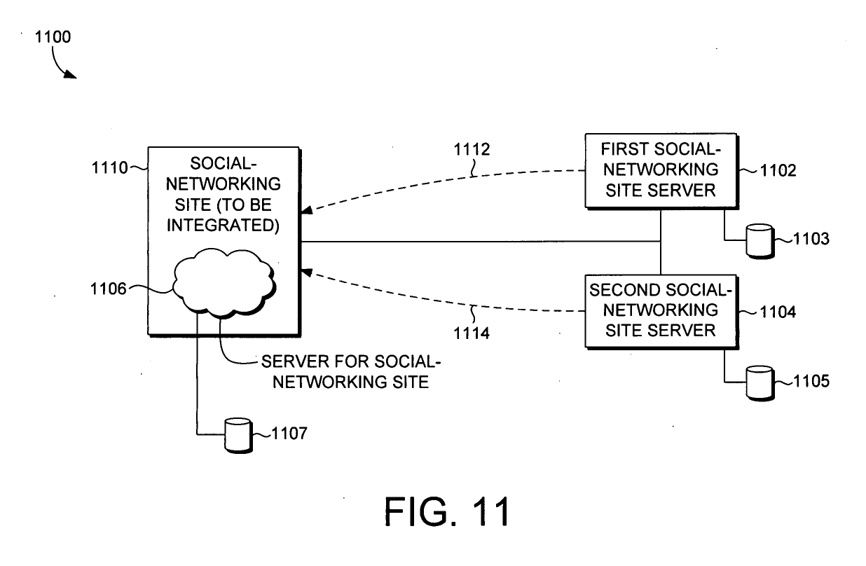

FIG. 11 illustrates a system 1100 for receiving updates communicated from a first social-networking site server and a second social-networking site server at a social-networking site to be integrated in accordance with an embodiment of the present invention. The system 1100 includes a first social-networking site server 1102; a second social-networking site server 1104; a server for a social-networking site 1106; a social-networking site 1110; a connection 1112 between the first social-networking site server 1102 and the social-networking site of interest 1110; and a connection 1114 between the second social-networking site server 1104 and the social-networking site of interest 1110.

Similar to the connections found in FIG. 10, in some embodiments, the connections 1112 and 1114 may be may be wired or wireless. Examples of particular wired embodiments, within the scope of the present invention, include USB connections and cable connections. Examples of particular wireless embodiments, within the scope of the present invention, include a near-range wireless network and radio-frequency technology. It should be understood and appreciated that the designation of “near-range wireless network” is not meant to be limiting, and should be interpreted broadly to include at least the following technologies: negotiated wireless peripheral (NWP) devices; short-range wireless air interference networks (e.g., wireless personal area network (wPAN), wireless local area network (wLAN), wireless wide area network (wWAN), Bluetooth™, and the like); wireless peer-to-peer communication (e.g., Ultra Wideband); and any protocol that supports wireless communication of data between devices. Additionally, persons familiar with the field of the invention will realize that a near-range wireless network may be practiced by various data-transfer methods (e.g., satellite transmission, telecommunications network, etc.) that are different from the specific illustrated embodiments.

In some embodiments, the social-networking site server 1106 may retrieve and/or receive updates from a first or second social-networking site server, 1102 and 1104, respectively. The updates may be integrated into the updates of the social-networking site 1110 through an integrative function of the social-networking site server 1106. The updates may be requested from the social-networking site 1110, or the updates may be transmitted to the social-networking site 1110 from the first and/or second social-networking site server 1102/1104 independent of a request from the social-networking site 1110. In alternative embodiments, the updates may be stored at the first social-networking site server 1102; a first database 1103 associated with the first social-networking site server 1102; the second social-networking site server 1104; a second database 1105 associated with the second social-networking site server 1104; the social-networking site server 1106; and/or a third database 1107 associated with the social-networking site server 1106. The request for updates and/or the updates sent in response to the request for updates may be transmitted via connection 1112 and/or connection 1114.

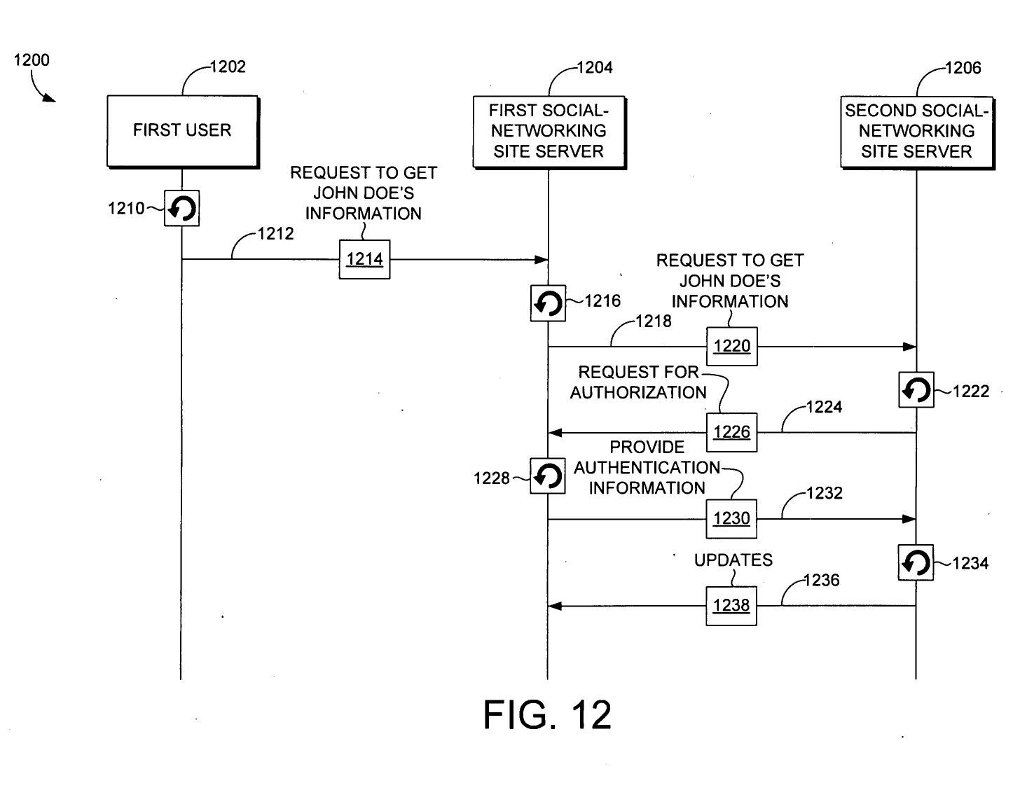

FIG. 12 is a flow diagram 1200 illustrating a method of receiving requested updates upon authentication from a first social-networking site server that a first user is associated with necessary authentication information in accordance with an embodiment of the present invention. Initially, as indicated at block 1210, a user request 1214 to obtain information associated with second user is generated at a computing device of a first user 1202. The second user may be referred to as, for example, “John Doe.”

The computing device from which the first user 1202 originates a request for information associated with a second user may be any type of computing device, such as, for example, computing device 100 described above with reference to FIG. 1. By way of example only and not limitation, the computing device may be a personal computer, desktop computer, laptop computer, handheld device, mobile handset, consumer electronic device, and the like. Additionally, the computing device may further include a keyboard, keypad, stylus, joystick, and any other input-initiating component that allows a user to provide wired or wireless data to a network, e.g., search queries, user preferences, and the like. It should be noted, however, that the present invention is not limited to implementation on such computing devices, but may be implemented on any of a variety of different types of computing devices within the scope of embodiments hereof.

The user request 1214 is then sent 1212 to a first social-networking site server 1204. At block 1216, a request 1240 to obtain information associated with a second user is generated at the first social-networking site server. In alternative embodiments, the request 1240 to obtain information associated with a second user may be the user request 1214 that is redirected from the first social-networking site server to an appropriate second social-networking site server 1206. After the request 1240 has been generated 1216, the request 1240 is sent 1218 to a second social-networking site server 1206. After the request 1240 is received, the second social-networking site server 1206 recognizes 1222 there is a need for authorization to access the requested information and, still at block 1222, a request for authorization 1226 is generated. The request for authorization is then sent 1224 to the first social-networking site server 1204.

At block 1228, the first social-networking site server 1204 recognizes the requested user authentication information is present, and generates a response 1230 to provide authentication information to the second social-networking site server 1206. In some embodiments, the user authentication information may be provided to the first social-networking site server 1204 upon a user signing on to a first social-networking site. In the process of signing on to a first social-networking site, a user may provide authentication information to the first social-networking site server 1204. The authentication information of the first user may be stored at the first social-networking site server 1204 or, alternatively, the authentication information of the first user may be stored at a database that is accessible by the first social-networking site server 1204. In some embodiments, the authentication information of the first user may then be accessed, at block 1228, and provided in a response 1230 that is generated at the first social-networking site server 1204 and sent 1232 to the second social-networking site server 1206.

Once a response 1230 has been generated 1228, the response 1230 may be sent 1232 to the second social-networking site server 1206. The second social-networking site server 1206 may then generate 1234 a response 1238, where the response 1238 may comprise information associated with the second user. Information associated with the second user may comprise updates, profile information, and the like. Once the response 1238 has been generated 1234, the response 1238 may be sent 1236 to the first social-networking site server 1204.

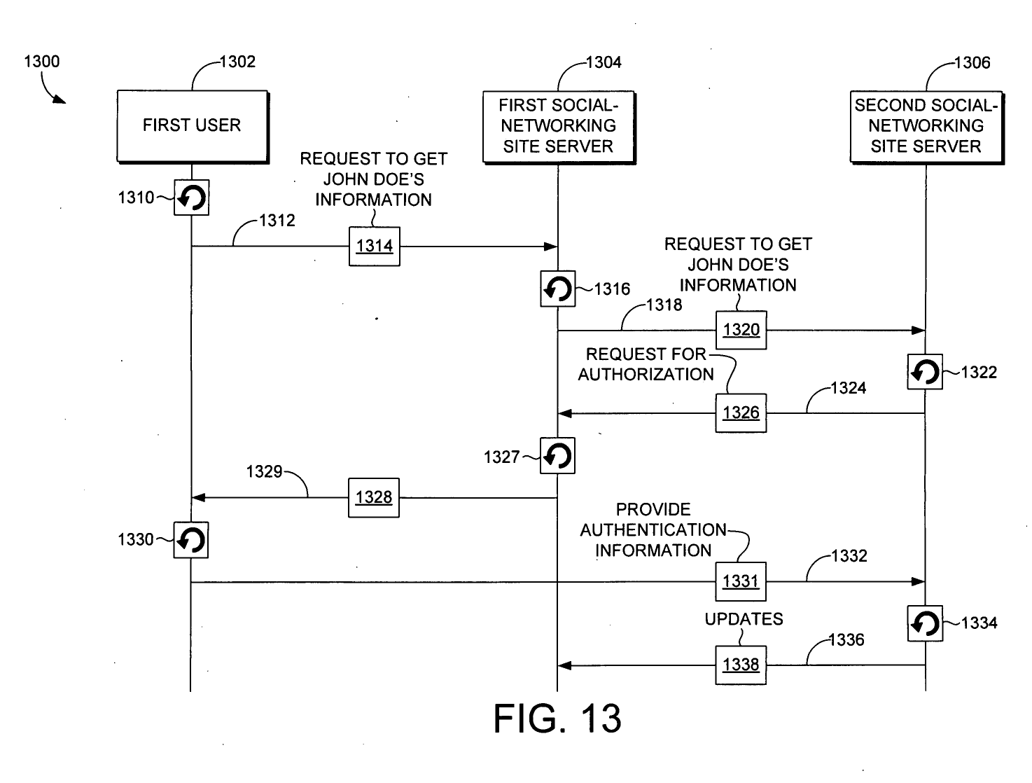

FIG. 13 is a flow diagram 1340 illustrating a method of receiving requested updates from a second user once a first user is authenticated, based on information provided by the first user, to view updates from the second user in accordance with an embodiment of the present invention. Initially, as indicated at block 1310, a user request 1314 to obtain information associated with second user is generated at a computing device of a first user 1302. The second user may be referred to as, for example, “John Doe.”

The user request 1314 is then sent 1312 to a first social-networking site server 1304. At block 1316, a request 1340 to obtain information associated with a second user is generated at the first social-networking site server. In alternative embodiments, the request 1340 to obtain information associated with a second user may be the user request 1314 that is redirected from the first social-networking site server to an appropriate second social-networking site server 1306. After the request 1340 has been generated 1316, the request 1340 is sent 1318 to a second social-networking site server 1306. After the request 1340 is received, the second social-networking site server 1306 recognizes 1322 there is a need for authorization to access the requested information and, still at block 1322, a request for authorization 1326 is generated. The request for authorization is then sent 1324 to the first social-networking site server 1304.

At block 1327, the first social-networking site server 1304 recognizes the requested user authentication information is not present, and generates a request 1328 for authentication information. The request 1328 is then sent 1329 to the first user 1302. In some embodiments, at block 1330 a user interface is generated. The first user 1302 may input authentication information into the user interface. Alternatively, the first user 1302 may provide permission for the request 1328 to access authentication information stored on the computing device of the first user. In alternative embodiments, a response 1331 is generated 1330 at a computing device of the first user 1302, the response 1331 comprising authentication information provided by the first user 1302.

Once a response 1331 has been generated 1330, the response 1331 may be sent 1332 to the second social-networking site server 1306. The second social-networking site server 1306 may then generate 1334 a response 1338, where the response 1338 may comprise information associated with the second user. Information associated with the second user may comprise updates, profile information, and the like. Once the response 1338 has been generated 1334, the response 1338 may be sent 1336 to the first social-networking site server 1304.

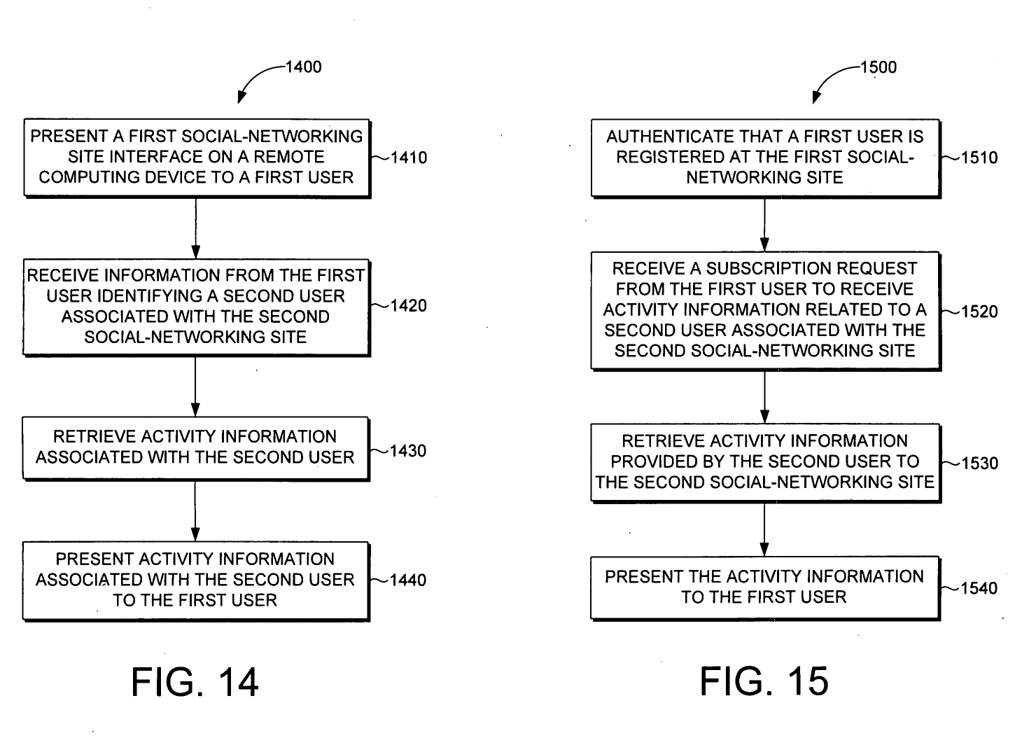

FIG. 14 is a flow diagram 1400 illustrating a method of presenting in a first social-networking site activity logged in a second social-networking site, in accordance with an embodiment of the present invention.

As indicated at block 1410, a first social-networking site interface is presented on a remote computing device to a first user. The first user may be associated with the first social-networking site. At block 1420, information is received from the first user identifying a second user associated with the second social-networking site. At block 1430, activity information associated with the second user is retrieved. The retrieval of the activity information may be facilitated by a first server associated with said first social-networking site requesting said activity information from a second server that is associated with said second social-networking site. In alternative embodiments, the activity information may be provided by the second user to the second social-networking site. At block 1440, activity information associated with the second user is presented to the first user. The activity information may be presented to the first user on the first social-networking site.

FIG. 15 is a flow diagram 1500 illustrating a method of presenting in a first social-networking site activity logged in a second social-networking site, in accordance with an embodiment of the present invention.

As indicated at block 1510, first user is authenticated as being registered at the first social-networking site. In some embodiments, the first user may be authenticated at an application server that hosts a second social-networking site. At block 1520, a subscription request is received from the first user to receive activity information related to a second user associated with the second social-networking site. The information related to the second user may be information that was provided by the second user to the second social-networking site. In alternative embodiments, the information related to the second user may be information that was provided by other users associated with the second social-networking site. At block 1530, activity information is retrieved, where the information is provided by the second user to the second social-networking site. In some embodiments, the retrieval of the activity information may be facilitated by a first server associated with said first social-networking site requesting said activity information from a second server that is associated with said second social-networking site. At block 1440, the activity information is presented to the first user. In some embodiments, the information may be presented to the first user on the first social-networking site.

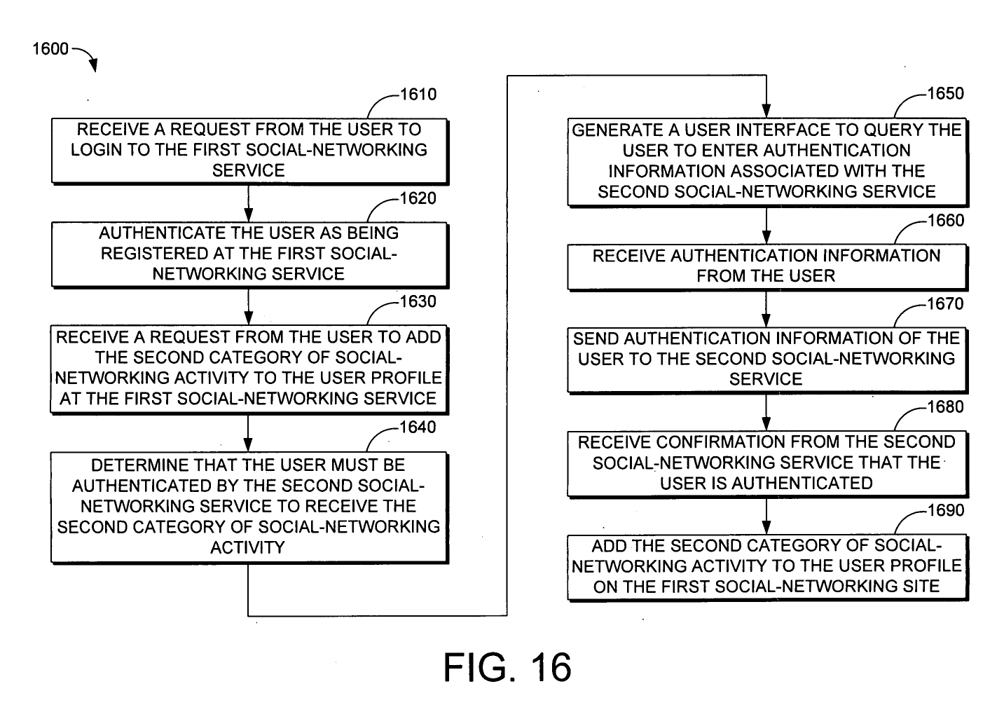

FIG. 16 is a flow diagram 1600 showing another embodiment of a method of associating at least a first category of social-networking activity from a first social-networking service and a second category of social-networking activity from a second social-networking service with a user profile at the first social-networking service, in accordance with an embodiment of the present invention.

As indicated at block 1610, a request is received from the user to login to the first social-networking service. In some embodiments, the user is associated with a first social-networking service. At block 1620, the user is authenticated as being registered at the first social-networking service. At block 1630, a request is received from the user to add the second category of social-networking activity to the user profile at the first social-networking service. At block 1640, it is determined that the user must be authenticated by the second social-networking service to receive the second category of social-networking activity. At block 1650, a user interface is generated to query the user to enter authentication information associated with the second social-networking service. At block 1660, authentication information is received from the user. At block 1670, authentication information of the user is sent to the second social-networking service. At block 1680, confirmation is received from the second social-networking service that the user is authenticated. At block 1690, the second category of social-networking activity is added to the user profile on the first social-networking site.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. Computer-readable media having computer-executable instructions embodied thereon that, when executed, perform a method of presenting in a first social-networking website (“site”) activity logged in a second social-networking site, the method comprising:
presenting a first social-networking site interface on a remote computing device to a first user, the first user associated with the first social-networking site;
receiving information from the first user, wherein the information identifies a second user, said second user associated with the second social-networking site;
retrieving activity information provided by the second user to the second social-networking site; and
presenting the activity information of the second user on the first social-networking site to the first user.

2. The media of claim 1, wherein the first social-networking site interface includes an updated list of activity information provided to the first user.

3. The media of claim 2, wherein the updated list of activity information provided to the first user includes the activity information of the second user.

4. The media of claim 3, wherein the activity information provided by the second user is automatically retrieved from the second social-networking site.

5. The media of claim 3, wherein the activity information provided by the second user is periodically retrieved from the second social-networking site.

6. The media of claim 1, further comprising:
presenting activity information provided by the second user to the first social-networking site;
integrating the activity information provided by the second user to the first social-networking site and the activity information provided by the second user to the second social-networking site; and
presenting the integrated activity information into a single uniform feed on the first social-networking site.

7. The media of claim 6, wherein the activity information provided by the second user to the first social-networking site is presented in a first font selected from at least one predetermined font.

8. The media of claim 7, wherein the activity information provided by the second user to the second social-networking site is presented in a second font selected from at least one predetermined font.

9. The media of claim 1, wherein said retrieving said activity information is facilitated by a first server associated with said first social-networking site requesting said activity information from a second server that is associated with said second social-networking site.

10. Computer-readable media having computer-executable instructions embodied thereon that, when executed, perform a method of presenting in a first social-networking website (“site”) activity logged in a second social-networking site, the method comprising:
authenticating at an application server that hosts a second social-networking site that a first user is registered at the first social-networking site;
receiving a subscription request from the first user to receive activity information related to a second user, the second user associated with the second social-networking site;
retrieving activity information provided by the second user to the second social-networking site; and
presenting the activity information to the first user.

11. The media of claim 10, wherein the activity information provided by the second user is automatically retrieved from the second social-networking site.

12. The media of claim 10, wherein the activity information provided by the second user is periodically retrieved from the second social-networking site.

13. The media of claim 10, further comprising:
presenting activity information provided by the second user to the first social-networking site;
integrating the activity information provided by the second user to the first social-networking site and the activity information provided by the second user to the second social-networking site; and
presenting the integrated activity information into a single uniform feed on the first social-networking site.

14. The media of claim 13, wherein the activity information provided by the second user to the first social-networking site is presented in a first font selected from at least one predetermined font.

15. The media of claim 14, wherein the activity information provided by the second user to the second social-networking site is presented in a second font selected from at least one predetermined font.

16. The media of claim 10, wherein said retrieving said activity information is facilitated by a first server associated with said first social-networking site requesting said activity information from a second server that is associated with said second social-networking site.

17. A method of associating at least a first category of social-networking activity from a first social-networking service and a second category of social-networking activity from a second social-networking service with a user profile at the first social-networking service, the method comprising:
receiving a request from the user to login to the first social-networking service;
authenticating the user as being registered at the first social-networking service;
receiving a request from the user to add the second category of social-networking activity to the user profile at the first social-networking service;
determining that the user must be authenticated by the second social-networking service to receive the second category of social-networking activity;
generating a user interface to query the user to enter authentication information associated with the second social-networking service;
receiving authentication information from the user;
sending authentication information of the user to the second social-networking service;
receiving confirmation from the second social-networking service that the user is authenticated; and
adding the second category of social-networking activity to the user profile on the first social-networking site.

18. The method of claim 17, further comprising:
presenting activity information provided by the second user to the first social-networking site;
integrating the activity information provided by the second user to the first social-networking site and the activity information provided by the second user to the second social-networking site; and
presenting the integrated activity information into a single uniform feed on the first social-networking site.

19. The method of claim 18, wherein the activity information provided by the second user to the first social-networking site is presented in a first font selected from at least one predetermined font.

20. The method of claim 19, wherein the activity information provided by the second user to the second social-networking site is presented in a second font selected from at least one predetermined font.
